(19) United States
(12) Patent Application Publication
(10) Pub. No.: US 2014/0101025 A1
(43) Pub. Date: Apr. 10, 2014

(54) ACCOUNTS WITH MULTIPLE PRE-AUTHORIZATION LEVELS

(71) Applicant: MOBIBUCKS CORP., Sunnyvale, CA (US)

(72) Inventors: Jorge M. Fernandes, Los Altos, CA (US); Ziad Alshobaki, Dubai (AE)

(73) Assignee: MOBIBUCKS CORP., Sunnyvale, CA (US)

(21) Appl. No.: 13/786,408

(22) Filed: Mar. 5, 2013

Related U.S. Application Data
(63) Continuation-in-part of application No. 13/755,421, filed on Jan. 31, 2013.
(60) Provisional application No. 61/711,957, filed on Oct. 10, 2012.

(51) Int. Cl. G06Q 40/02

(52) U.S. Cl. CPC G06Q 40/025
USPC 705/38

(57) ABSTRACT

A system and method of pre-configuring a financial account for later transactions is provided. The system includes an account server, which, after receiving a request to configure an account from an initiator, sends a prompt for identification verification information to the initiator. After receiving the verification information, the server configures the account with limitations based at least in part on the verification information. The server may also send the initiator a secure, compact identification code that can be used for later transactions. These later transactions are checked against the pre-defined limitations associated with the account, and they are processed if they fall within the limitations.

### BACKGROUND

Unless otherwise indicated herein, the approaches described in this section are not prior art to the claims in this application and are not admitted to be prior art by inclusion in this section.

Traditionally, an account at a financial institution, such as a bank account, has certain fixed limitations on transactions that can be performed on it. Certain accounts, for example, may limit ATM cash withdrawals to $300 total per day. For transactions that fall outside the limitations, the account holder may be required to go through extra verification procedures. For example, for a cash withdrawal greater than $300, the account holder may be required to show a form of photo identification (for example, a driver's license) to a teller at a bank branch.

Typically, the account holder must go through these extra verification procedures every time a transaction falls outside the account's fixed limitations. Moreover, usually the account holder has no control over the fixed limitations—they are pre-set by the financial institution.

### SUMMARY

Embodiments of the present invention provide a method of configuring a financial account. The configuration includes limitations on later transactions, based on user identity information provided at the time of configuration. One embodiment includes a computer-implemented method for such a configuration process. A server device receives a request to configure an account from an initiator. The server device sends a prompt for verification information to the initiator. The prompt for information may be a list of verification options including the account limitation associated with each option. The initiator sends the verification information to the server. Optionally, the server creates the account if one does not already exist. The server configures the account with the limitation associated with the later transaction. The limitation depends, at least in part, on the verification information. The server device optionally generates a compact identification code and sends it to the initiator.

According to a further optional embodiment, after the account is configured, the server device receives data for an active transaction associated with the account. The transaction data is compared to the limitation, and the transaction is processed if the data is within the limitation.

Another embodiment of the present invention includes a machine-readable medium including instructions executable by the machine. These instructions cause the machine to accept receipt of a request to configure an account from an initiator. The machine is instructed to send the initiator a prompt for verification information. This may comprise sending to the initiator a list of verification options including the account limitation associated with each verification option. The machine is instructed to receive the verification information from the initiator. Optionally, the machine is instructed to create an account if one does not already exist. The machine is instructed to configure the account with the limitation associated with a later transaction. The limitation depends, at least in part, on the verification information. The machine is optionally instructed to generate a compact identification code and send it to the initiator.

### BRIEF DESCRIPTION OF THE DRAWINGS

FIG. 1 is a block diagram of an account configuration system according to an embodiment of the present invention.

FIG. 2 is a flowchart of an account configuration method according to an embodiment of the present invention.

FIG. 3 is a block diagram of an account configuration system using an outside source of verification information, according to an embodiment of the present invention.

FIG. 4 is a flowchart of an account configuration method using an outside source of verification information, according to an embodiment of the present invention.

FIG. 5 is a flowchart of an account configuration or modification method, according to an embodiment of the present invention.

FIG. 6 is a flowchart of an account modification method using account data, according to an embodiment of the present invention.

FIG. 7 is a flowchart of an account configuration method, with a subsequent transaction method included, according to an embodiment of the present invention.

FIG. 8 is a flowchart of an account configuration method, with a subsequent mobile-phone-initiated transaction method included, according to an embodiment of the present invention.

FIG. 9 is a block diagram of a point-of-sale transaction system using a configured account, according to an embodiment of the present invention.

FIG. 10 is a block diagram of an online sale transaction system using a configured account, according to an embodiment of the present invention.

FIG. 11 is a block diagram of a peer-to-peer transaction system using a configured account, according to an embodiment of the present invention.

### DETAILED DESCRIPTION

The present disclosure relates to accounts used for monetary or credit transactions. In particular, the present disclosure relates to pre-configuring such an account to allow or deny a later transaction based on certain limitations.

Described herein are methods of creation and use of a type of financial transaction account, wherein transaction limitations can be customized by the account holder, using pre-authorization techniques. This type of financial account may be associated with money, credit, securities, or the like. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

As described above, for a typical account at a financial institution, transactions that fall outside certain limits often require extra levels of identity verification. The account holder must provide this extra verification each time such a transaction is requested. The embodiments described below obviate the need for this extra effort while still maintaining security for both the account holder and the financial institution. Transactions are thus streamlined. Also, the embodiments described below allow the account holder to have some input into the limitations placed on his accounts, while maintaining security for the account holder and the financial institution, and ensuring compliance with all appropriate financial regulations.

In one embodiment, an account has extra verification data associated with it. This data is stored and then keyed to more compact verification information—for example, to a mobile phone number and/or a user-defined personal identification number (PIN). The account holder can then perform transactions that would normally require extra identification procedures simply by providing this compact verification information.

In general, the account described herein is a regular bank account, possibly with added features. The account described herein may also be similar to the MOBI account, described in U.S. Patent Publication No. 2009/0024533 A1 for “Payment Systems and Methods” filed Aug. 29, 2007, or U.S. patent application Ser. No. 13/755,421 for “Self-authenticating peer-to-peer transaction” filed Jan. 31, 2013, both of which are owned by the assignee of the present invention, and both are incorporated herein in their entirety.

The extra verification data provided at account configuration may also be required to satisfy various “know your customer” (KYC) regulations. These are regulations regarding which forms of identification are acceptable for various transactions. For example, these regulations may stipulate that customers wishing to make higher value transactions must present more secure forms of identity verification.

The configuration methods described herein are not limited to new accounts; existing accounts can be reconfigured using the same methods. The account holder may change the extra verification data associated with the account, and/or the limitations associated with the account may change automatically based on account usage data.

In the following descriptions, it is understood that all messages involved can be sent via a number of means; for example, wired or wireless voice or data channels, or the like. These means may be private or explicitly secure communication means; for example, encrypted voice or data channels, or the like. Communication means include (i) messages to and/or from a mobile device such as email messages, voice calls, data messages, text messages, messages sent via other applications (e.g., Facebook, Linked In, Skype and the like) and (ii) the same sort of messages sent to and/or from a stationary device such as a desk top computer or browser running on a television.

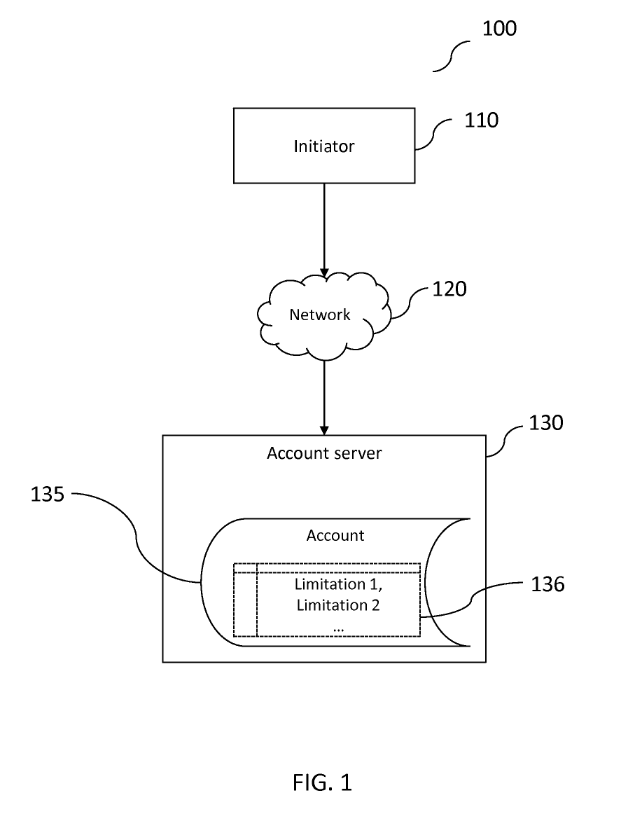

FIG. 1 shows a block diagram 100 exemplary of an embodiment of this invention. An initiator 110—for example, a user who wants to open a new account or re-configure an existing account—communicates with an account server 130 through a network 120 via any of a number of communication means. The network 120 could be, for example, the Internet. The account server 130 maintains an account 135. The account 135 is configured with one or more limitations 136 associated with later transactions. These limitations 136 will be compared with data from the later transactions in order to allow or deny the processing of the transaction.

There are many examples of limitations 136 that could be associated with the account 135. Such examples include, but are not limited to, a maximum limit on cash withdrawals, or a maximum limit on purchases, or other maximum transaction limits; limitations on currencies in which transactions may be denominated; or limitations on transaction types (for example, on-line purchases may restricted, but point-of-sale purchases may be allowed). Other examples include: maximum deposit limits, limitations on the number of transactions in a given time period (e.g., day, week, or month), restrictions on the location of the transaction, restriction on type of item or service purchased, or a restriction on people to whom cash is sent.

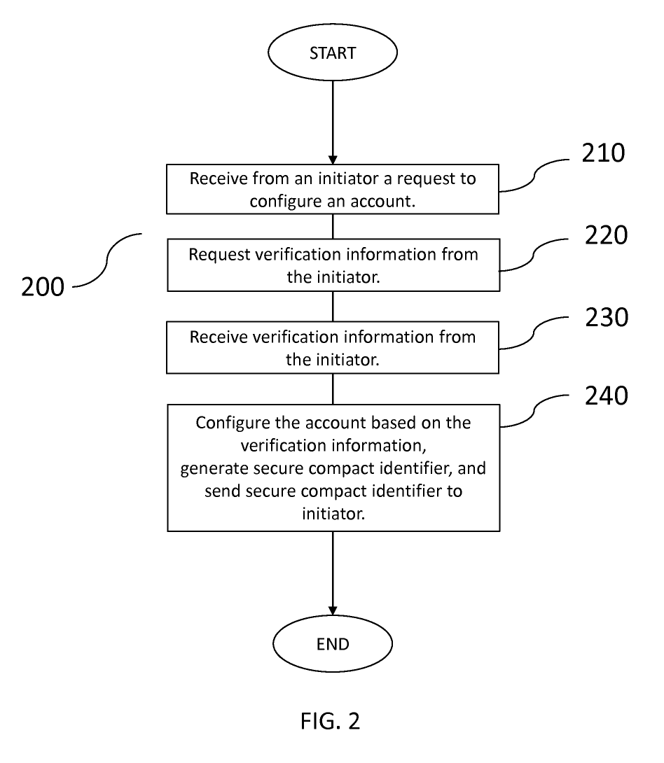

FIG. 2 shows a flowchart 200 of an account configuration process. The process represented by flowchart 200 may be implemented via a telephone call (to an automated voice system, for example), or a series of text messages, or a web site on a mobile or stationary device, or interactively through a bank branch or financial institution office, or at a merchant point-of-sale (POS), or any combination of these. In step 210 of flowchart 200, the account server 130 receives from the initiator 110 a request to configure an account 135. This request may be sent, for example, from an Internet-connected mobile or stationary device, via a web site form; it may also be sent via a text message or a phone call from a mobile device, for example, to an automated voice interactive system. In step 220, the account server 130 sends a request to the initiator 110 for verification information. The request sent in step 220 may be in the form of, for example, a list or menu of different verification options and the account limitations to which they correspond. Such a menu may be presented, for example, on a web page, or as part of an automated voice system (in the case where the operation is taking place over the phone), or interactively, by a merchant at a POS, or an agent at a bank. For example, one menu option may be to type in an existing PIN, corresponding to an account maximum transaction limit of $100, or $300; another option may be to scan or photograph an identifying document, such as a passport or driver's license, to enable a higher account transaction maximum (for example, $500, or $1000, or $1500). Other examples of verification information include a series of identifying questions presented to the initiator, an account number of a second account (which has, for example, already been configured), a photograph of the initiator, a government-issued identifier, or a trusted-source issued identifier.

Other identity verification information options may also be presented; for example, biometric information, such as fingerprint or retinal scans. This type of verification information may allow even higher transaction limits, for example, $5000 or $10,000. Different combinations of options may be available for different limitations—for example, both photo ID's and biometric information may be required for transactions involving certain currencies. Also, different levels may be set for different types of transactions; for example, a user may want to configure an account for a $500 purchase limit but a $100 cash withdrawal limit. In this way, an account may be configured with multiple limitations. Other limitation combinations—for example, limitations consistent with KYC regulations—may be available. Transactions on the account may still be subject to some limitations that are not based on the initiator's configuration choices; for example, a total cash withdrawal limit of $1000 per day may be fixed by the financial institution and not be configurable. The account server 130 may also request, in step 220, the initiator's mobile phone number, which may serve as part of the initiator's identification for each later transaction.

In step 230 of FIG. 2, the account server 130 receives the verification information from the initiator 110. This step may comprise, for example, the initiator choosing from the menu of different verification options, and then providing the information associated with that option. For example, the initiator may choose to provide an image of her passport, for a maximum transaction limit of $1000. The initiator then can submit an image of the required document; for example, by scanning it, or taking a picture of it with her mobile phone camera, or with a web camera attached to or embedded in a stationary computer. Also, the initiator may send the image via a postal service, or may show it to an authorized agent.

The verification information requested may require specialized hardware to submit; for example, a fingerprint scanner. In this case, the initiator may visit an office, such as a bank branch, to complete the configuration procedure.

In step 240 of FIG. 2, the account server 130 configures the account 135 based on the verification information acquired in step 230. This step may comprise, for example, storing the received verification information and associated transaction limitations in a secure storage area, and/or generating a secure compact identifier, such as a PIN, that the initiator will use (along with, for example, his mobile phone number) for identity verification for each later transaction. The secure PIN may be sent to the initiator, for example, via physical mail (e.g., U.S. Postal Service), or it may be given to the initiator if he is in a bank branch office or POS. Alternatively, the server may request the initiator to select a secure PIN. This request may be sent by any of the means discussed above: web site, phone call/voice message system, text message, or interactively at a POS or office, and the like. The initiator may respond with the secure PIN using similar communication means. The server may optionally send the initiator a temporary validation code (or temporary PIN) to use while waiting to receive the permanent secure PIN.

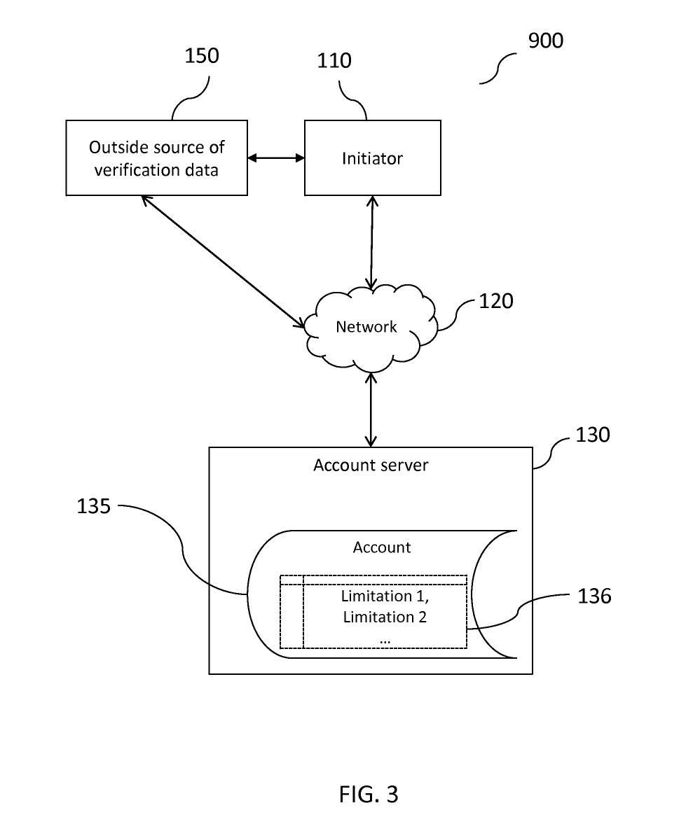

The configuration method described in FIG. 2 may utilize access to outside sources to simplify the verification process. Shown in FIG. 3 is a block diagram 900 of a system that includes an outside source of verification data 150, which can communicate to the initiator 110 directly and/or through the network 120. The outside source 150 also communicates with the account server 130 through the network 120.

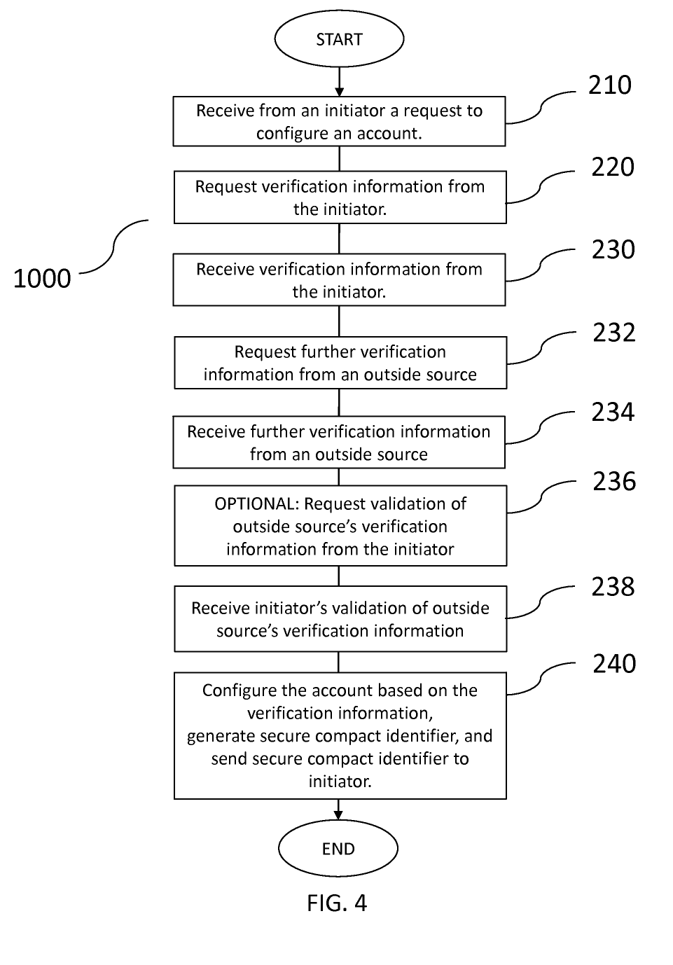

FIG. 4 shows a flowchart 1000 illustrating how the system 900 illustrated in FIG. 3 would operate. As in FIG. 2, the initiator 110 sends a request to configure an account to the server 130 in step 210, and the server requests verification information from the initiator in step 220. The server receives verification information in step 230; this verification information may include a key that allows the server to request information from an outside source. For example, the initiator may send a user ID and a password so that the server 130 can access an outside financial account, or another account similarly configured with extra verification information. In step 232, the server 130 uses this information to request further verification from the outside source 150; for example, the server may request an account balance of an outside financial account, or it may request the verification information with which another, similar, account was configured. In step 234, the server 130 receives this additional verification information from the outside source 130. Optionally, in steps 236 and 238, the server requests that the initiator validate the information it has received from the outside source, and the initiator sends validation of this outside data. The account is configured, and a compact identifier is generated, in step 240.

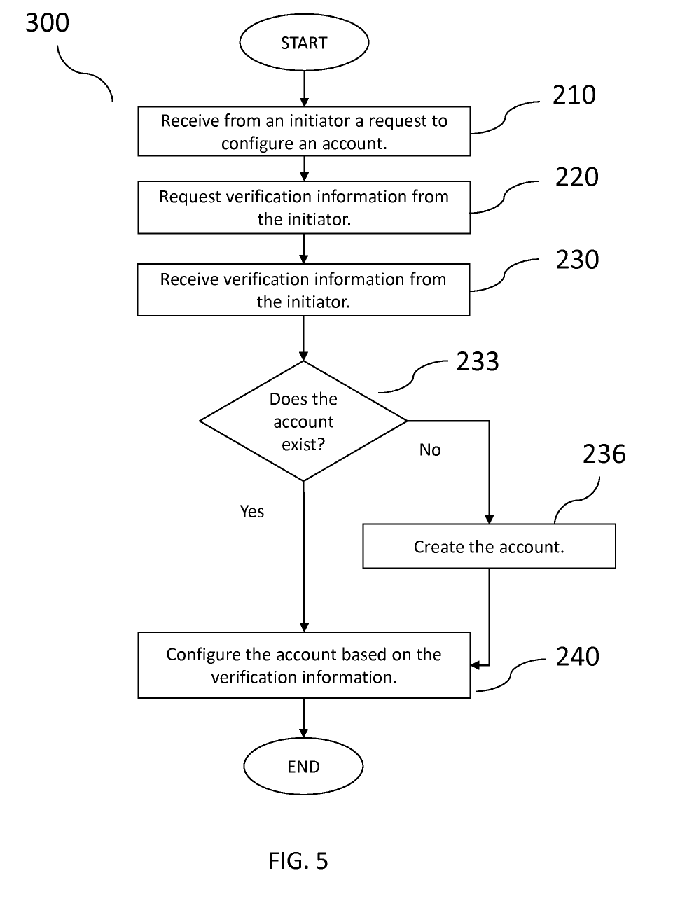

The configuration method described in FIG. 2 may be further refined. FIG. 5 shows a flowchart 300 of an account configuration process that accommodates initializing new accounts or re-configuring existing accounts. For example, the account holder (initiator) may desire to increase daily withdrawal limits on an existing account; he would therefore need to re-configure the account by submitting a more secure form of identity verification. In step 210, the account server 130 receives from the initiator 110 a request to configure a new account, or re-configure an existing account. In step 220, the account server 130 sends a request to the initiator 110 for verification information. Again, the request sent in step 220 may be in the form of, for example, a web site page that comprises a menu of different verification options and the account limitations to which they correspond. Again, this step may also include a request for a mobile phone number, as well as a request for a previously defined secure PIN, if the initiator wishes to modify an existing account, rather than create a new account. In step 230, the account server 130 receives the verification information from the initiator. In step 235, the account server 130 checks to see if the account exists; for example, by comparing the mobile phone number submitted with its database of existing accounts. If the account does not exist, it is created in step 238. In step 240, the account (new or existing) is again configured based on the verification information received in step 230.

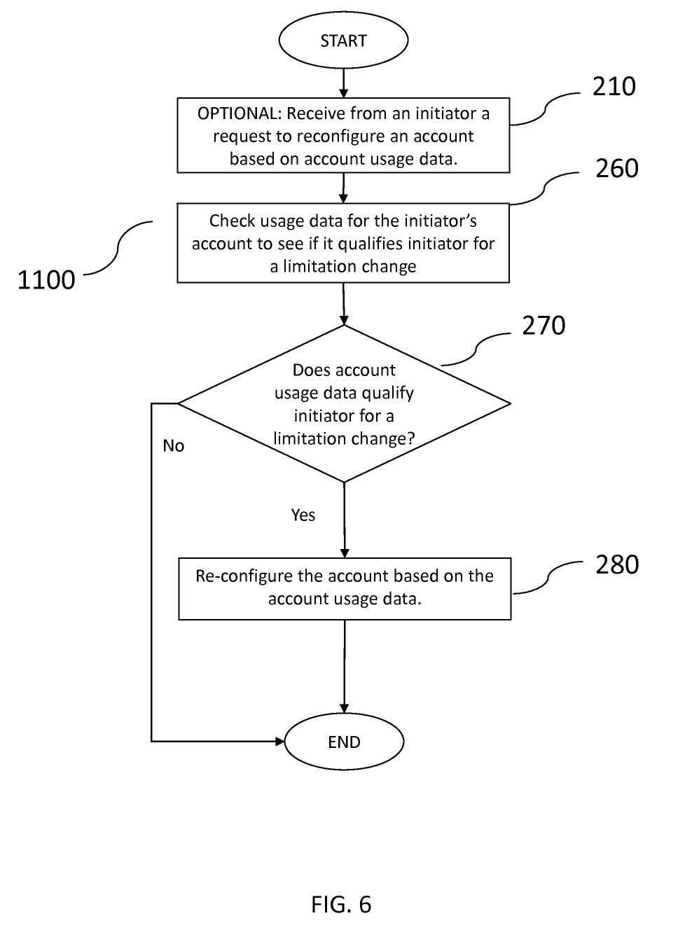

As another embodiment, existing accounts may be reconfigured based on account usage data; for example, on account transaction history or average daily account balances. FIG. 6 shows a flowchart 1100 for such a method. In step 210 of FIG. 6, the initiator requests to reconfigure the account based on account usage data. Note that step 210 is optional; the flowchart 1100 may be run automatically, thus periodically checking to see if the account can be refigured. For example, the server may check account usage every month to see if limitations may be upgraded, or if the need to be downgraded. In step 260, the usage data is checked to see if it qualifies the initiator for a change in limitations. For example, if the initiator keeps an average daily balance of more than $1000 for a month, then he may be eligible to increase his maximum withdrawal limit by $50. If the usage data qualifies the initiator for a change in limitations, the account is re-configured with the new limitations in step 280.

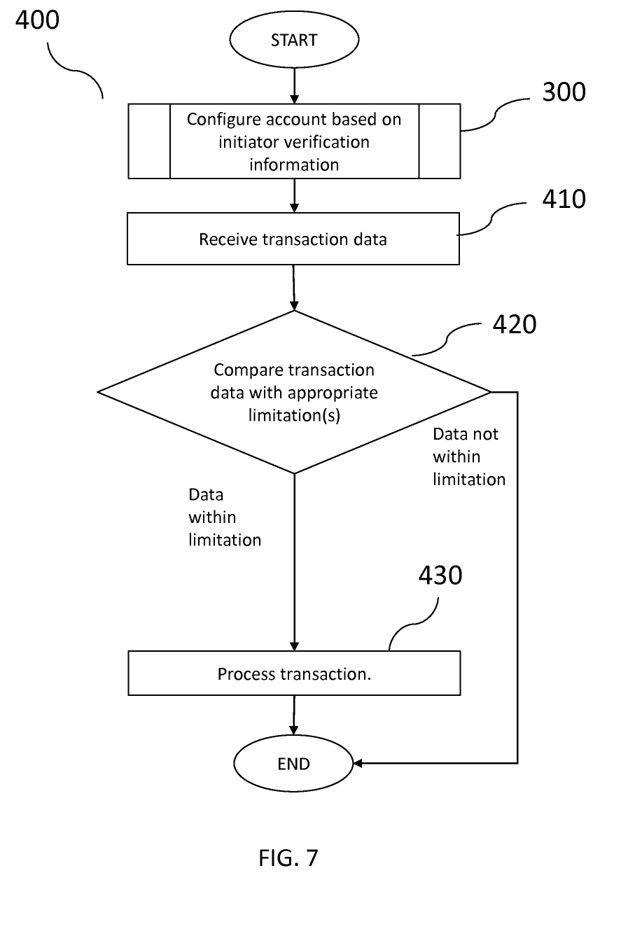

FIG. 7 shows an extended flowchart 400 of the configuration process, followed by the verification of a later transaction against the limitations set up during account configuration. Element 300 of FIG. 7 represents the account configuration process as described in any of the embodiments above. The account 135 is ready to accept transaction requests. In step 410, the account server 130 receives data for a transaction associated with the account 135. The data may be sent from, for example, the initiator, or from a merchant, or a combination of the two. This data may comprise, for example, the type of transaction, the amount of the transaction, and the transaction's currency.

As an example of such a transaction, the initiator may want to make a point-of-sale purchase. The merchant may send part of the transaction data—for example, the purchase amount—to the server. The initiator may then complete the purchase by sending to the server her secure PIN, for example. The server receives both pieces of this transaction data in step 410 of FIG. 7.

In step 420 of FIG. 7, the server compares the transaction data with the pre-configured limitations 136 associated with the account 135. In the point-of-sale purchase example, this comparison could comprise comparing the purchase price to the pre-configured maximum purchase amount associated with the account 135. If the transaction data falls within the pre-configured limits—for example, if the transaction price is below the POS purchase price limit—then the transaction is processed, as shown in step 430. If not, the transaction is not processed. In this case, the initiator may be given the opportunity (not shown) to provide other verification information in order to re-configure the account with increased limitations; in effect, repeating step 300 in FIG. 7.

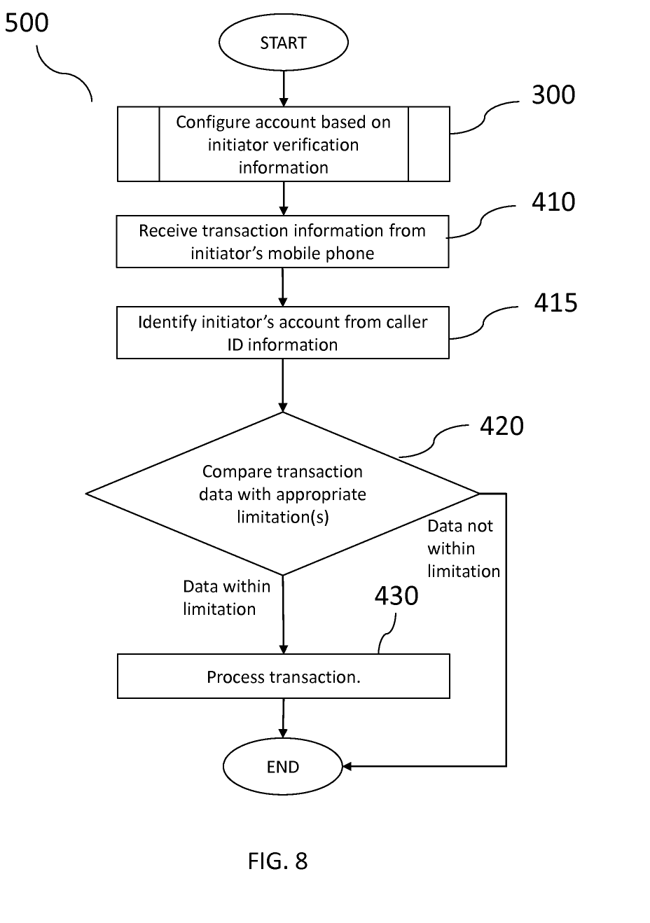

FIG. 8 shows a flowchart 500 detailing a variation on the extended process described in FIG. 7. Again, the configuration process 300 takes place, and the account 135 is ready to accept transaction requests. In step 410, the server 130 receives data for a transaction; all or part of this data is sent from the initiator's mobile device. In the point-of-sale example, the initiator may, for example, send her secure PIN from her mobile device via a text message. Again, some information about the transaction may be sent to the server by another party; for example, the merchant may send the purchase price information to the server. In step 415, the server uses caller ID information, including, for example, the initiator's mobile phone number, to identify the initiator's account. As before, the server compares the transaction data with the pre-configured limitations 136 associated with the account 135 in step 420, and the transaction is processed, if the transaction data falls within the pre-configured limitations for the account, in step 430.

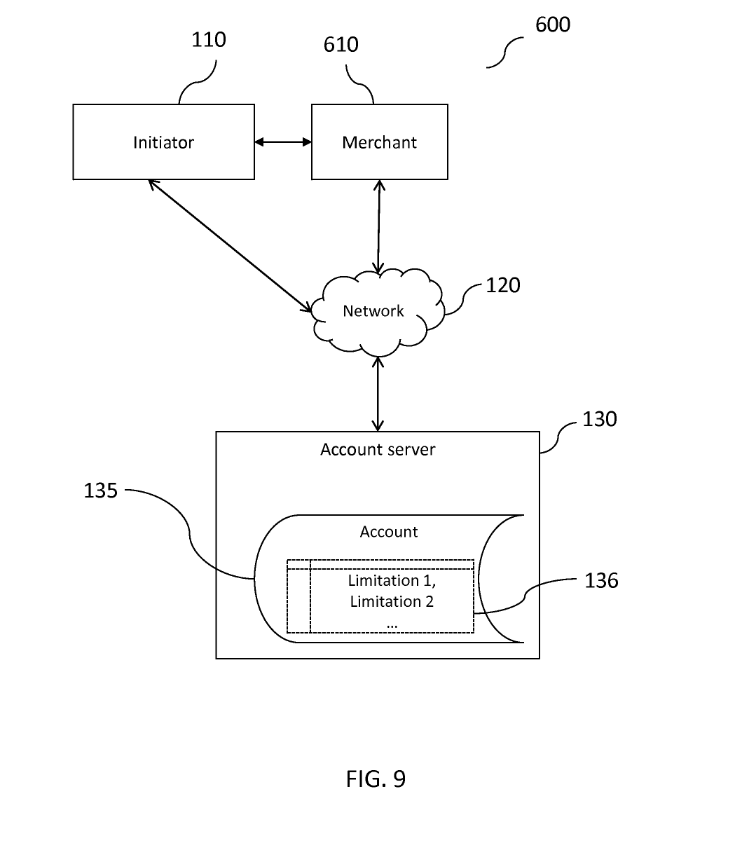

FIG. 9 shows a block diagram 600 of a point-of-sale transaction system using a pre-configured account. In this system, an initiator 110 makes a purchase from a merchant 610. Both the initiator 110 and the merchant 610 may transmit transaction information to the account server 130, via a network 120. For example, the merchant 610 may send the purchase price, and other product information, to the server 130 via a web-enabled device, and the initiator 110 may confirm the purchase, for example, by texting his secure PIN to the server 130 using his mobile device. Note that, in this example, the network 120 comprises multiple communication channels—the merchant 610 may use the Internet, while the initiator 110 uses a cellular network.

In the example illustrated in FIG. 9, once the account server 130 receives transaction data from the merchant 610 and/or initiator 110, the account server 130 may identify the initiator's account 135, for example, by using caller ID information. The server 130 then compares the transaction data to limitations 136 associated with the account 135, and, if the transaction falls within the limitations 136, the server 130 will process the transaction. At this point, the server 130 may send a message to the merchant 610, and possibly the initiator 110, indicating that the purchase has been approved (i.e., that the purchase price funds have been transferred to the merchant), and the merchant 610 may give the purchased product to the initiator 110. This notice of approval may, for example, be a web-based message sent to the merchant 610, and/or a text message sent to the initiator 110.

FIG. 9 may also represent a system wherein an initiator 110 withdraws cash from his account 135. In this case, the merchant 610 has a cash register. As described above, both the initiator 110 and the merchant 610 may send transaction information to the server 130, and, again, the server 130 uses this information, and the limitations 136 associated with the initiator's account 135, to approve or deny the transaction. If the transaction is approved, notice, again, is sent to the merchant 610 and possibly the initiator 110, and the merchant 610 can then hand the cash to the initiator 110.

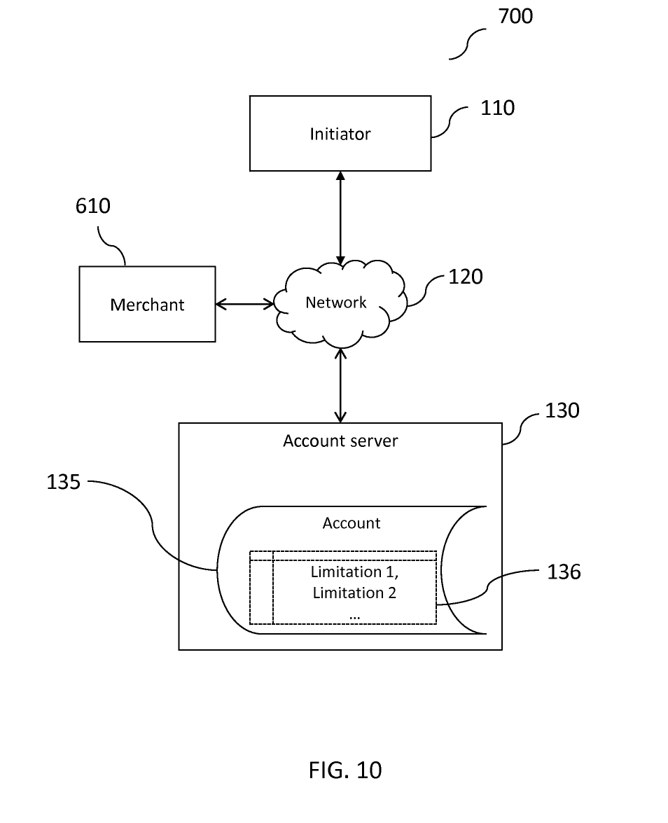

FIG. 10 shows a block diagram 700 of an online transaction system using a pre-configured account. In this case, the initiator 110 makes an online purchase from the merchant 610, through, for example, the merchant's web site. The initiator 110 may access the merchant's web site on a stationary or mobile device, connected to a network 120; for example, the Internet. Both the initiator 110 and the merchant 610 may transmit transaction information to the account server 130 via the Internet. For example, after the initiator 110 chooses to pay for the purchase using her pre-configured account 135, the initiator may then be prompted by the web site to enter her mobile phone number and secure PIN. Again, the server 130 then compares the transaction data to limitations 136 associated with the account 135, and, if the transaction falls within the limitations 136, the server 130 will process the transaction. The server 130 may then send a confirmation message to the merchant 610 and the initiator 110, and the merchant 610 can ship the product to the customer. The confirmation message from the server 130 may be sent to the initiator 110 and merchant 610, for example, via an e-mail message.

For both of the systems depicted in FIG. 9 and FIG. 10, the server 130 may deny the purchase, if the purchase data does not fall within the limitations 136 of the pre-configured account 135. As described above for FIG. 7, the initiator 110 in this case may be given the opportunity to provide other verification information in order to re-configure the account with increased limitations. For example, for the on-line purchase case of FIG. 10, the initiator may be re-directed to a web site where he can re-configure his account, providing extra verification data, if necessary.

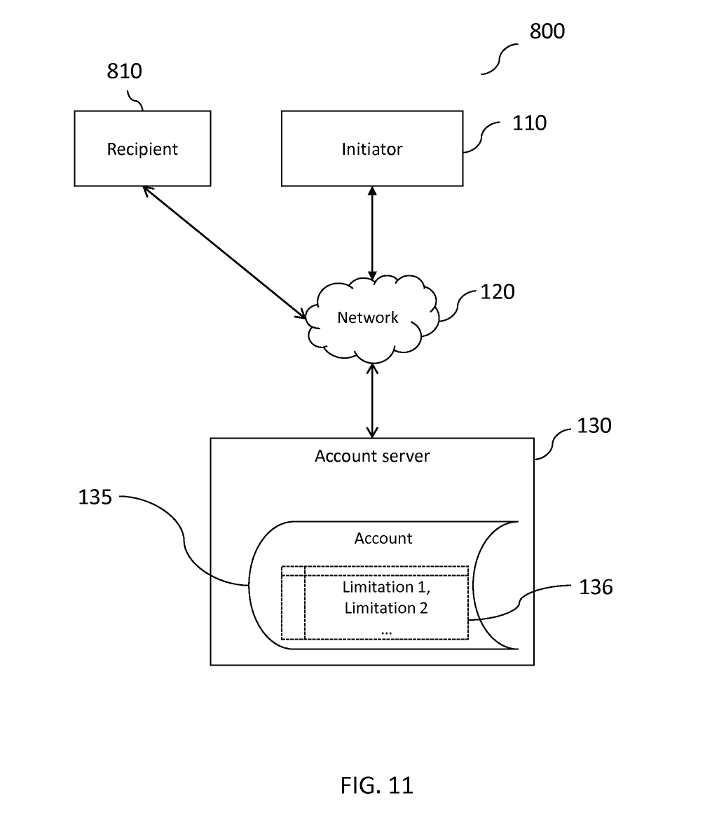

FIG. 11 shows a block diagram 800 of a peer-to-peer transaction using a pre-configured account exemplifying the present invention. In FIG. 11, the initiator 110 sends a remittance to a recipient 810. Both initiator 110 and recipient 810 connect to the account server 130 via a network 120, for example, a cellular network. The initiator may begin by sending transaction information and recipient information to the account server 130. This information may be sent, for example, in a text message, and may include, for example, the recipient's mobile phone number and the amount to remit to the recipient. The server 130 may identify the initiator's account 135 from, for example, the initiator's caller ID information. The server 130 then compares the transaction data to limitations 136 associated with the account 135, and, if the transaction falls within the limitations 136, the server 130 may proceed with the transaction. For example, the server 130 may then ask for additional verification information from the initiator 110 and recipient 810. When all verification procedures are completed successfully, funds may be transferred from the initiator's account to the recipient's account. If the recipient does not have an account, he may be prompted to create one.

As set forth above, the present invention provides a multi-step system to pre-configure, and re-configure, accounts to operate with different limitations on transactions. In one specific example, this system may operate in the following manner:
1. Computer code that controls the system to accept receipt of a request to configure an account for a later transaction. This request may be made from an initiator via a web site.
2. Computer code that controls the system to prompt the initiator for verification information. This prompt may be in the form of a menu of different verification options and their corresponding account limitations.
3. Computer code that controls the system to accept receipt of the initiator's verification information. This may consist of:
   a. Accepting the initiator's choice of a configuration option;
   b. Prompting the initiator for the appropriate verification information; for example, the initiator's mobile phone number, and a photograph or a scan of the initiator's passport;
   c. Accepting the initiator's identity verification information; for example, an uploaded photograph of the initiator's passport, taken with the camera built into the initiator's computer.
4. Computer code that controls the system to check if an account exists for the initiator; if not, then the computer code instructs the system to create a new account.
5. Computer code that controls the system to configure the newly created, or existing, account with the limitations associated with the verification information provided by the initiator, and to generate a secure, compact identifier (for example, a secure PIN) that the initiator will use in later transactions. Alternatively, the system may send a request for a self-generated PIN to the initiator, and subsequently receive the initiator's PIN.

The system as set forth herein also provides methods to verify later transactions with the pre-configured limitations described above. In one specific example, this system may verify transactions in the following manner:
1. Computer code that controls the system to accept receipt of a data for an active transaction on the account; this may be, for example, for a point-of-sale purchase, where a merchant sends purchase price information to the server, and the initiator (purchaser) sends her compact identifying information to the server, via her mobile phone.
2. Computer code that controls the system to identify the initiator's account, using the initiator's caller ID information.
3. Computer code that controls the system to compare the transaction data with the account's limitations; for example, the system may compare the purchase price with the pre-configured POS purchase price limits on the account.
4. Computer code that controls the system to process the transaction if the transaction data is within the limitations; for example, if the purchase price is less than the POS purchase price limit set for the account. In this example, the code then may control the system to notify the merchant and initiator of the successful transaction.

The above description illustrates various embodiments along with examples of how aspects of the present invention may be implemented. For example, direct communication, U.S. mail, phone calls, text messages, data messages or e-mail through wired or wireless voice or data channels, encrypted or not encrypted, and the like may all be considered communication means. A mobile device may be a mobile phone, two-way pager, tablet or notebook computer, and the like. A compact identifier may be a PIN, or a pseudorandom code, or the like. Secure identity verification may be a photograph of one of the transacting parties, or a photograph of identification documents, such as a passport, license, or utility bill, or the like, or biometric information such as a fingerprint or retinal scan.

The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A computer-implemented method for configuring an account associated with money or credit belonging to an initiator, the method comprising:
receiving, at a server device from the initiator, a request to configure the account for a later transaction;
sending, from the server device to the initiator, a prompt for verification information;
receiving, at the server device from the initiator, the verification information; and
configuring the account with a limitation, the limitation being associated with the later transaction;
wherein the limitation depends at least in part on the verification information.

2. The method of claim 1, further comprising, before the step of configuring the account with a limitation:
determining if the account exists; and
creating the account if the account does not exist.

3. The method of claim 1, wherein the step of sending the prompt for verification information comprises:
sending, from the server device to the initiator, a list of verification options including the account limitation associated with each of the verification options;
receiving, at the server device from the initiator, a verification option selected from the verification options; and
sending, from the server device to the initiator, the prompt for the verification information associated with the verification option selected.

4. The method of claim 1, wherein the step of receiving a request to configure the account comprises (a) receiving the request from a networked computer, (b) receiving the request from an initiator mobile device via a text message, or (c) receiving the request from an initiator mobile device via a phone call.

5. The method of claim 1, wherein the step of receiving the verification information comprises (a) receiving the verification information from a networked computer, (b) receiving the verification information from an initiator mobile device via a text message, or (c) receiving the request from an initiator mobile device via a phone call.

6. The method of claim 1, wherein the verification information comprises one of a personal identification number, an account number of a second account, a government issued identifier, a trusted source issued identifier, usage data of the account, a photograph of the initiator, or a photograph of identifying documents belonging to the initiator.

7. The method of claim 1, wherein the verification information comprises a photograph from a passport of the initiator.

8. The method of claim 1, wherein the limitation is one of a maximum transaction amount, a transaction currency type, a transaction type, a maximum number of transactions per time period, a restriction on the location of the transaction, a restriction on type of item or service purchased, or a restriction on people to whom cash is sent.

9. The method of claim 1, further comprising, after the step of configuring the account:
generating, by the server device, a compact identification code; and
sending, by the server device to the initiator, the compact identification code.

10. The method of claim 9 wherein the step of sending, by the server to the initiator, the compact identification code comprises sending, by the server to the initiator, the compact identification code via a physical postal service.

11. The method of claim 1, further comprising, after the step of configuring the account:
receiving, by the server, data for an active transaction associated with the account;
comparing the data with the limitation; and
processing the active transaction if the data is within the limitation.

12. The method of claim 11, wherein the active transaction is an on-line or point-of-sale purchase.

13. The method of claim 11, wherein the active transaction is a peer-to-peer transaction.

14. The method of claim 11, wherein the active transaction is a cash withdrawal from the account.

15. The method of claim 11, wherein the step of receiving data for an active transaction comprises receiving, by the server device from the initiator, the data for an active transaction.

16. The method of claim 15,
wherein the step of receiving data for an active transaction comprises receiving, by the server device from an initiator mobile device, the data for the active transaction; and
further comprising, before the step of processing the active transaction, identifying, from caller identification information associated with the initiator mobile device, the account;
wherein an account number of the account corresponds to a mobile telephone number of the initiator mobile device.

17. A machine-readable medium including instructions executable by the machine for configuring an account associated with money or credit belonging to an initiator, the instructions causing the machine to:
accept receipt, from an initiator, of a request to configure an account for a later transaction;
send to the initiator a prompt for verification information;
accept receipt, from the initiator, of the verification information; and
configure the account with a limitation, the limitation being associated with the later transaction;
wherein the limitation depends at least in part on the verification information.

18. The machine-readable medium of claim 17, further comprising instructions causing the machine, before configuring the account with a limitation, to:
determine if the account exists; and
create the account if the account does not exist.

19. The machine-readable medium of claim 17, wherein the instructions causing the machine to send to the initiator the prompt for verification information comprise:
sending to the initiator a list of verification options including the account limitation associated with each of the verification options;
receiving from the initiator a verification option selected from the verification options; and
sending to the initiator the prompt for the verification information associated with the verification option selected.

20. The machine-readable medium of claim 17, wherein the verification information comprises one of a personal identification number, an account number of a second account, a government issued identifier, a trusted source issued identifier, usage data associated with the account, a photograph of the initiator or a photograph of identifying documents belonging to the initiator.

21. The machine-readable medium of claim 17, wherein the limitation is one of a maximum transaction amount, a transaction currency type, or a transaction type, a maximum number of transactions per time period, a restriction on the location of the transaction, a restriction on type of item or service purchased, or a restriction on people to whom cash is sent.

22. The machine-readable medium of claim 17, further comprising instructions causing the machine, after configuring the account, to:
generate a compact identification code; and
send the compact identification code to the initiator.

23. The machine-readable medium of claim 17, further comprising instructions causing the machine, after configuring the account, to:
accept receipt of data for an active transaction associated with the account;
compare the data with the limitation; and
process the active transaction if the data is within the limitation.

24. The machine-readable medium of claim 23, wherein the active transaction is one of an on-line purchase, a point-of-sale purchase, a peer-to-peer transaction, or a cash withdrawal from the account.

25. The machine-readable medium of claim 23,
wherein the instructions causing the machine to accept receipt of data for an active transaction comprise instructions causing the machine to accept receipt, from an initiator mobile device, of data for the active transaction;
further comprising instructions causing the machine, before processing the active transaction, to identify, from caller identification information associated with the initiator mobile device, the account; and
wherein an account number of the account corresponds to a mobile telephone number of the initiator mobile device.
